(19) United States
(12) Patent Application Publication
(10) Pub. No.: US 2010/0032319 A1
(43) Pub. Date: Feb. 11, 2010

(54) DIAGNOSTIC CASSETTE FOR ELECTROCHEMICAL MEASURING APPARATUS AND METHOD OF DIAGNOSING ELECTROCHEMICAL MEASURING APPARATUS

(76) Inventors: Jun Okada, Tokyo (JP); Nobuhiro Gemma, Yokohama-shi (JP); Sadato Hongo, Yokohama-shi (JP); Tetsuya Kuwabara, Fuchu-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/408,980

(22) Filed: Mar. 23, 2009

(30) Foreign Application Priority Data
Aug. 6, 2008 (JP) 2008-202987

(51) Int. Cl. G01N 27/26

(52) U.S. Cl. 205/787; 204/412; 205/775; 204/401

(57) ABSTRACT

A diagnostic cassette for diagnosing an electrochemical measuring apparatus is disclosed. The electrochemical measuring apparatus is to perform electrochemical measurement on a sample in a sample cassette, which is attachable to and detachable from the electrochemical measuring apparatus, and includes a first working electrode interface, a first counter electrode interface, and a first reference electrode interface. The diagnostic cassette is attachable to and detachable from the electrochemical measuring apparatus like the sample cassette, and includes a second working electrode interface connectable to the first working electrode interface, a second counter electrode interface connectable to the first counter electrode interface, a second reference electrode interface connectable to the first reference electrode interface, and one of a capacitor and a resistor including one terminal connected to the second working electrode interface and the other terminal connected to the second counter electrode interface and the second reference electrode interface.

### CROSS-REFERENCE TO RELATED APPLICATIONS

This application is based upon and claims the benefit of priority from prior Japanese Patent Application No. 2008-202987, filed Aug. 6, 2008, the entire contents of which are incorporated herein by reference.

### BACKGROUND OF THE INVENTION

1. Field of the Invention

The present invention relates to a method of easily testing the condition of an electrochemical measuring apparatus used for performing electrochemical measurement by using a detection cassette and an apparatus for the test.

2. Description of the Related Art

An electrochemical measuring method such as voltammetry has very high selectivity and can perform high-sensitivity measurement, and hence is frequently used for the analysis and evaluation of clinical biological samples, environmental samples, and the like.

With advances in genetic engineering, it is possible to genetically diagnose and prevent diseases in the medical field. This technique is called genetic diagnosis, which allows diagnosis or prediction of a disease before it develops or at a very early stage by detecting a human genetic defect or change that is the cause of the disease. Advances in studies on the relationships between genotypes and diseases, together with decoding of the human genome, are implementing medical treatments suitable for the genotypes of individuals (tailor-made medical services). It is therefore very important to easily detect genes and determine genotypes.

Nucleic acid detection methods and nucleic acid detection apparatuses to which the above electrochemical measuring method is applied are under development as methods to allow highly accurate and easy detection. For example, Jpn. Pat. Appln. KOKAI Publication No. 2004-125777 has proposed a system that automatically performs detection processing for a sample nucleic acid sequence, from a reaction to liquid feeding and measurement, by inserting a nucleic acid detection cassette into an electrochemical measuring apparatus. The nucleic acid detection cassette includes a working electrode to which a nucleic acid probe is immobilized, a counter electrode, a reference electrode, and a channel that allows a sample nucleic acid solution to flow on the electrodes. The electrochemical measuring apparatus includes a temperature control system necessary for a nucleic acid reaction, a reagent feeding system, and an electrochemical measuring system for detection. This system is expected as a system that can easily perform nucleic acid detection.

Recently, the development of such apparatuses has already shifted from research applications to applications for actual diagnosis and the like. Demands have therefore arisen for improvement in reliability. In applications for diagnosis and the like, an enormous number of samples are processed. Even if, therefore, a trouble occurs in an electrochemical measuring apparatus, the abnormality is difficult to recognize. In addition, even if a result suspicious of a trouble is output, it is not easy for a person without expert skill to diagnose whether the result indicates a trouble. Furthermore, similar problems arise in apparatuses that perform electrochemical measurement on other types of materials as detection targets as well as nucleic acids.

### BRIEF SUMMARY OF THE INVENTION

According to an aspect of the present invention, a diagnostic cassette for diagnosing an electrochemical measuring apparatus is provided. The electrochemical measuring apparatus is to perform electrochemical measurement on a sample in a sample cassette, which is attachable to and detachable from the electrochemical measuring apparatus, and includes a first working electrode interface, a first counter electrode interface, and a first reference electrode interface. The diagnostic cassette is attachable to and detachable from the electrochemical measuring apparatus like the sample cassette, and includes a second working electrode interface connectable to the first working electrode interface, a second counter electrode interface connectable to the first counter electrode interface, a second reference electrode interface connectable to the first reference electrode interface, and one of a capacitor and a resistor including one terminal connected to the second working electrode interface and the other terminal connected to the second counter electrode interface and the second reference electrode interface.

According to another aspect of the present invention, a method of diagnosing the electrochemical measuring apparatus is provided. The method includes steps of loading the diagnostic cassette into the electrochemical measuring apparatus to perform electrochemical measurement, and diagnosing, from an output value obtained by the electrochemical measurement, whether electrochemical control on the metadata measuring apparatus is normally performed.

### BRIEF DESCRIPTION OF THE SEVERAL VIEWS OF THE DRAWING

FIG. 1 is a block diagram schematically showing a nucleic acid detection apparatus and a nucleic acid detection cassette;

FIG. 2 is a circuit diagram showing the connection between the potentiostat circuit shown in FIG. 1 and the electrodes of the nucleic acid detection cassette;

FIG. 3 is a flowchart of a normal nucleic acid detection process;

FIG. 4 is a flowchart of a diagnostic process for an electrochemical measuring system;

FIG. 5 is a graph showing a normal current signal obtained when a diagnostic cassette is measured by a linear sweep voltammetry method using a potentiostat circuit;

FIG. 6 is a flowchart of an analysis process of diagnosing a nucleic acid detection apparatus on the basis of the current signal obtained by a diagnostic cassette;

FIG. 7 is a view showing abnormality contents predicted in the diagnosis shown in FIG. 6;

FIG. 8 is a perspective view of a diagnostic cassette;

FIG. 9 is a view showing the diagnostic substrate shown in FIG. 8;

FIG. 10 is a sectional view showing an example of the sectional structure of the element shown in FIG. 9;

FIG. 11 is a graph showing the theoretical current values obtained when measurement is performed by the linear sweep voltammetry method using an element having a capacitance characteristic;

FIG. 12 is a graph showing the theoretical current values obtained when measurement is performed by using the linear sweep voltammetry method using an element having a resistance characteristic;

FIG. 13 is a view showing an element formed of a capacitor having an SiO₂ thin layer;

FIG. 14 is a graph showing the current waveform obtained from a capacitor in diagnosis using a diagnostic cassette according to the first embodiment;

FIG. 15 is a graph showing the current waveform obtained from a resistor in diagnosis using a diagnostic cassette according to the second embodiment;

FIG. 16 is a graph showing the current waveform obtained from a capacitor in diagnosis using a diagnostic cassette according to the third embodiment; and

FIG. 17 is a view showing the connection relationship between a capacitor or resistor, a working electrode, a counter electrode, and a reference electrode.

### DETAILED DESCRIPTION OF THE INVENTION

A nucleic acid detection apparatus and a nucleic acid detection cassette designed for a nucleic acid as a sample will be described first. A diagnostic cassette according to an embodiment will then be described.

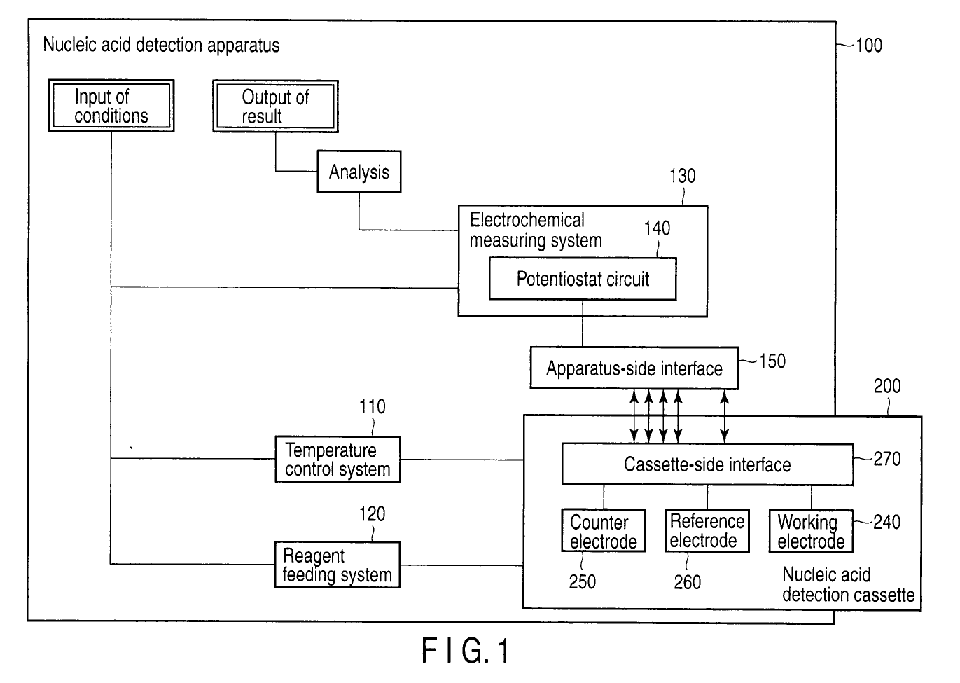

As shown in FIG. 1, a nucleic acid detection apparatus 100 includes a temperature control system 110 necessary for a nucleic acid reaction, a reagent feeding system 120, and an electrochemical measuring system 130 for detection. The electrochemical measuring system 130 includes a potentiostat circuit 140 to execute current measurement. The nucleic acid detection apparatus 100 also includes an apparatus-side interface (first interface) 150. The apparatus-side interface (first interface) 150 includes a first working electrode interface, a first counter electrode interface, and a first reference electrode interface. The potentiostat circuit 140 is electrically connected to the first working electrode interface, first counter electrode interface, and first reference electrode interface of the apparatus-side interface (first interface) 150.

A nucleic acid detection cassette 200 includes a working electrode 240, a counter electrode 250, and a reference electrode 260. For example, the nucleic acid detection cassette 200 includes working electrodes 240, at least one counter electrode 250, and at least one reference electrode 260. In general, the working electrode 240 is used as a nucleic acid detection electrode. The nucleic acid detection cassette 200 also includes a detection-cassette-side interface (third interface) 270. The detection-cassette-side interface (third interface) 270 includes a third working electrode interface, a third counter electrode interface, and a third reference electrode interface. The working electrode 240, the counter electrode 250, and the reference electrode 260 are electrically connected to the third working electrode interface, third counter electrode interface, and third reference electrode interface of the detection-cassette-side interface (third interface) 270, respectively. Although not shown, the nucleic acid detection cassette 200 has a channel allowing a solution containing a detection target nucleic acid and/or a nucleic acid recognition body to flow. The working electrode 240, the counter electrode 250, and the reference electrode 260 are provided in the channel.

When the nucleic acid detection cassette 200 is loaded into the nucleic acid detection apparatus 100, the apparatus-side interface (first interface) 150 is electrically connected to the detection-cassette-side interface (third interface) 270. That is, the first working electrode interface, first counter electrode interface, and first reference electrode interface of the apparatus-side interface 150 are electrically connected to the third working electrode interface, third counter electrode interface, and third reference electrode interface of the detection-cassette-side interface 270, respectively.

The apparatus-side interface 150 includes probe pins, connectors, and the like for electric connection. If the apparatus-side interface 150 includes probe pins, the cassette-side interface 270 includes pads. If the apparatus-side interface 150 includes male connectors, the cassette-side interface 270 includes female connectors. If the contact resistance between these interfaces greatly varies or disconnection or short circuit occurs, large noise is generated in an obtained current signal, or no current value can be obtained (the current value becomes 0).

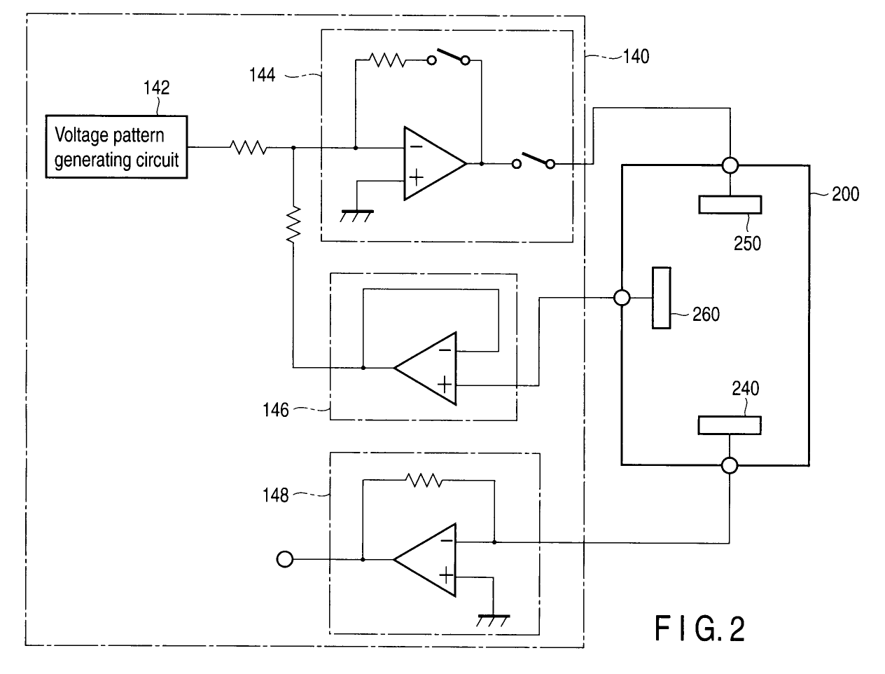

As shown in FIG. 2, the potentiostat circuit 140 includes a voltage pattern generating circuit 142, an inverting amplifier 144, a voltage follower amplifier 146, and a trans-impedance amplifier 148. The inverting amplifier 144, the voltage follower amplifier 146, and the trans-impedance amplifier 148 are respectively connected to the counter electrode 250, reference electrode 260, and working electrode 240 of the nucleic acid detection cassette 200. The potentiostat circuit 140 monitors the voltage applied between the working electrode 240 and the reference electrode 260 and sweeps the voltage while controlling the voltage at the counter electrode 250 by feedback. If there is a local solution resistance between the working electrode 240 and the counter electrode 250/reference electrode 260, the resistance is controlled by a compensation circuit. If a trouble occurs in even part of the inverting amplifier 144, the voltage follower amplifier 146, or the trans-impedance amplifier 148, a proper current signal cannot be obtained.

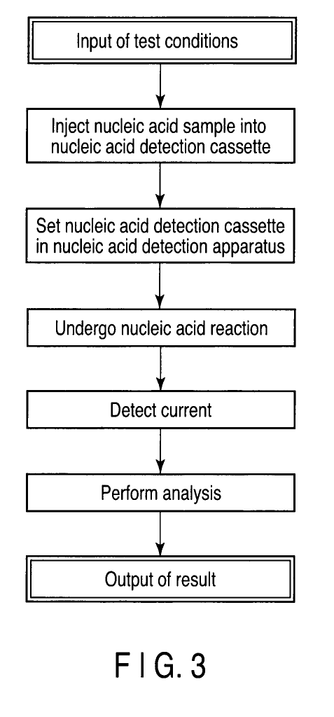

As shown in FIG. 3, in normal nucleic acid detection, first of all, test conditions are input. A nucleic acid sample is then injected into the detection cassette. Thereafter, the detection cassette is set in the nucleic acid detection apparatus. In the nucleic acid detection apparatus, a nucleic acid reaction and current detection are performed. After this operation, the cassette analyzes an obtained current signal and outputs the nucleic acid detection result.

The reliability of the function of the electrochemical measuring system 130 of the nucleic acid detection apparatus 100 may deteriorate in terms of the following items due to external noise, deterioration in components, variations in power supply voltage, local solution resistance accompanying variations in reagent concentration, and variations in electric capacitance:
the potential difference to be applied to a working electrode and a counter electrode/reference electrode;
a feedback circuit for potential difference control;
a voltage scan rate;
variations in local resistance compensation between working electrodes and a counter electrode/reference electrode;
variations in the contact resistance of an electrical interface between the nucleic acid detection cassette and the nucleic acid detection apparatus; and
the occurrence/nonoccurrence of disconnection or short circuit in an electrical interface between the nucleic acid detection cassette and the nucleic acid detection apparatus.

Conventionally, an oscilloscope or tester is used to check each part in diagnosis on each item. For this reason, the user needs to have an expert skill and knowledge and use specialized tools.

Consider a technique of performing electrochemical measurement by injecting, into a nucleic acid detection cassette, a standard reagent as a solution of a material that causes oxidation or a reduction reaction, and performing diagnosis based on the obtained current. According to this technique, large errors occur due to the concentration of an oxidized or reduced material and electrode surface states, and hence reliability is poor in measurement in a microchannel and at microelectrodes.

The present invention relates to a technique of diagnosing the electrochemical measuring system 130 of the nucleic acid detection apparatus 100 by using a diagnostic cassette attachable to and detachable from the nucleic acid detection apparatus 100 like the nucleic acid detection cassette 200. More specifically, the present invention is directed to a diagnostic cassette and a diagnosis method using the diagnostic cassette. This diagnostic cassette is loaded into a diagnosis target apparatus in place of a detection cassette to perform electrochemical detection, and the normality/abnormality of the nucleic acid detection apparatus is diagnosed on the basis of the output result.

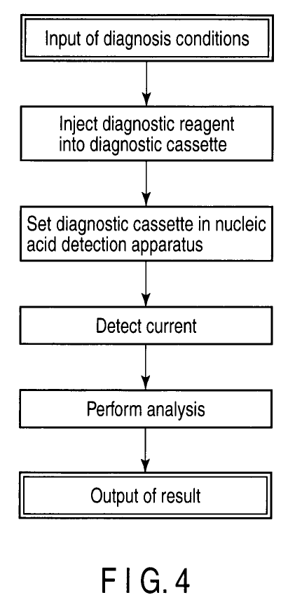

In diagnosis by a diagnostic cassette, as shown in FIG. 4, first of all, a capacitor diagnosis mode, resistor diagnosis mode, or the like is input as a diagnosis condition. A diagnostic reagent as an electrolyte is injected into the diagnostic cassette instead of a nucleic acid sample, as needed. If a diagnostic reagent is incorporated in the diagnostic cassette in advance, this step is not necessary. In addition, if the diagnostic cassette has a cassette arrangement that requires no reagent, the step is not necessary. Thereafter, as in normal nucleic acid detection, the diagnostic cassette is set in the nucleic acid detection apparatus. Current detection is then performed in the nucleic acid detection apparatus. Subsequently, the cassette analyzes the obtained current signal, and outputs the diagnosis result.

The following is a case in which a nucleic acid detection apparatus is diagnosed by using a diagnostic cassette.

<Preparation>

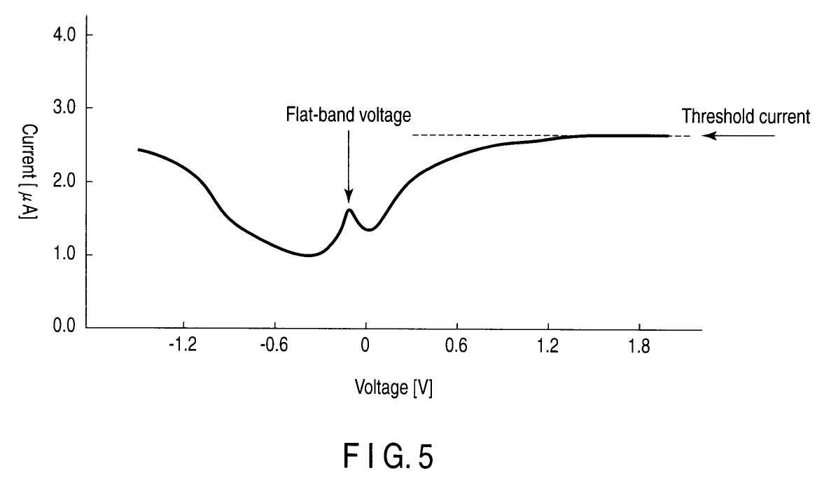

First of all, a current signal in the diagnostic cassette is measured by the linear sweep voltammetry method using the potentiostat circuit that operates normally. This diagnostic cassette has a channel on an internal diagnostic substrate. In the channel, SiO₂ electrodes (thickness: 5 nm), counter electrodes, and reference electrodes are provided on an N-type Si substrate. An electrolyte obtained by dissolving an electrolyte in a solvent is injected into the channel in advance. FIG. 5 shows the result obtained by measuring a current value by using the diagnostic cassette and performing sweeping at a scan rate of 0.3 V/sec. The detailed structure of the diagnostic cassette will be described later. Based on this measurement result, for example, the allowable width of flat-band voltage values required for the detection apparatus is set to −0.1±0.05 V, and the allowable width of threshold current values is set to 2.6±0.3 μA.

<Diagnosis on Nucleic Acid Detection Apparatus>

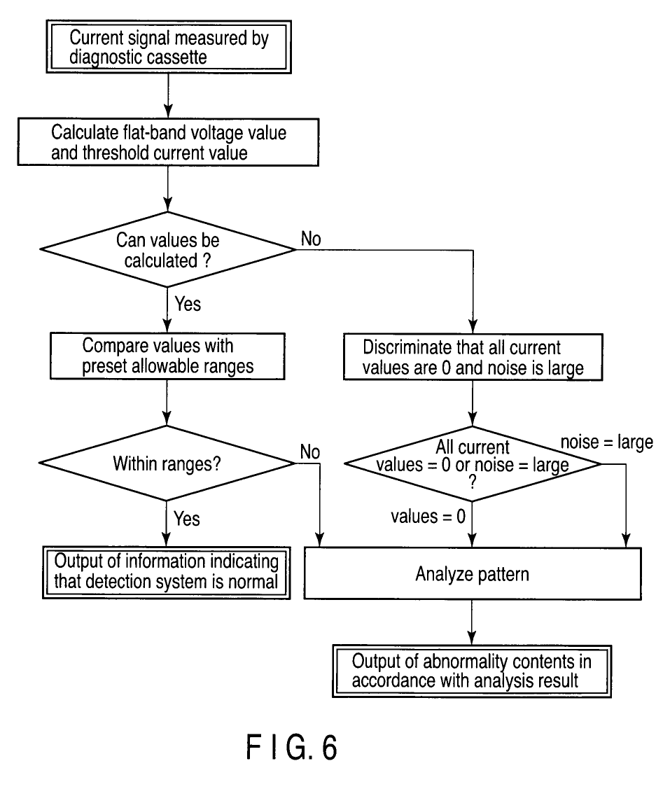

As shown in FIG. 6, this diagnostic cassette is loaded into the nucleic acid detection apparatus as a diagnosis target, and a current value is measured. Flat-band voltage values and threshold current values are calculated from measured current signals from all the electrodes. If flat-band voltage values and threshold current values can be calculated, the calculated values are respectively compared with the preset allowable ranges. If the comparison results on all the electrodes fall within the allowable ranges, the nucleic acid detection apparatus outputs a diagnosis result indicating that the current detection system is normal. If flat-band voltage values and threshold current values cannot be calculated, it is discriminated whether they cannot be calculated because all the current values are 0 or noise is too large. If the comparison results fall outside the allowable ranges or flat-band voltage values and threshold current values cannot be calculated, the nucleic acid detection apparatus outputs a diagnosis result indicating that the current detection system is abnormal, in accordance with each pattern.

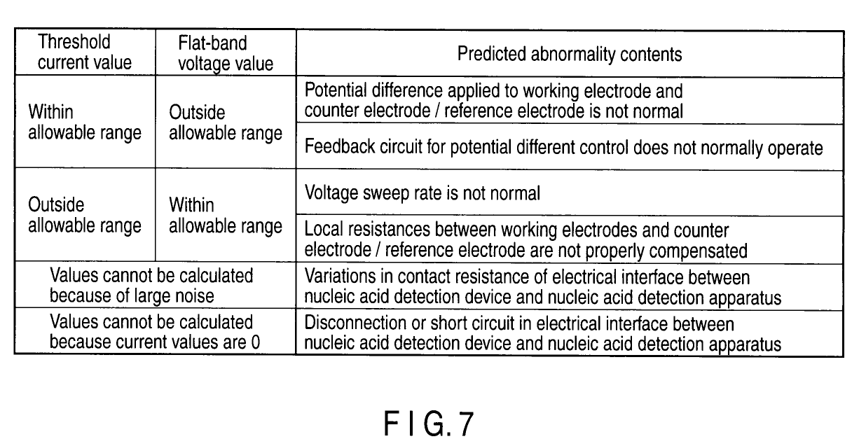

FIG. 7 shows the abnormality contents predicted when flat-band voltage values and threshold current values fall outside the allowable ranges and when they can not be calculated. The contents shown in FIG. 7 represent an example. Performing more detailed diagnosis can diagnose a trouble in more detail.

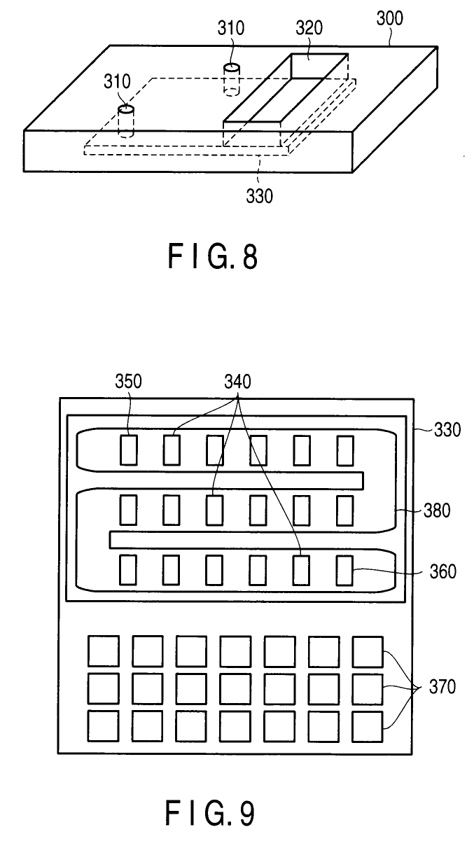

A diagnostic cassette 300 will be described below with reference to FIGS. 8 and 9.

The diagnostic cassette 300 has an arrangement similar to that of the nucleic acid detection cassette 200 attachable to and detachable from the nucleic acid detection apparatus 100, and is attachable to and detachable from the nucleic acid detection apparatus 100 like the nucleic acid detection cassette 200.

More specifically, as shown in FIG. 8, the diagnostic cassette 300 contains a diagnostic substrate 330. As shown in FIG. 9, the diagnostic substrate 330 includes a diagnosis-cassette-side interface (second interface) 370 to be electrically connected to the nucleic acid detection apparatus, a channel 380 for accommodating and holding a diagnostic reagent, and elements 340, a counter electrode 350, and a reference electrode 360, which are provided in the channel 380. For example, the diagnostic substrate 330 includes elements 340, at least one counter electrode 350, and at least one reference electrode 360. If no liquid diagnostic reagent is used, the channel 380 is not required, and it suffices to provide elements on the substrate.

Each element 340 is used to diagnose the electrochemical measuring system 130 of the nucleic acid detection apparatus 100, and outputs a signal for diagnosing the electrochemical measuring system 130 in response to a supplied input.

The channel 380 of the diagnostic substrate 330 has substantially the same shape as that of the channel of the nucleic acid detection cassette 200.

The elements 340, counter electrode 350, and reference electrode 360 of the diagnostic substrate 330 are arranged in substantially the same layout as that of the working electrodes 240, counter electrodes 250, and reference electrodes 260 of the nucleic acid detection cassette 200.

The element 340, counter electrode 350, and reference electrode 360 are electrically connected to the second working electrode interface, second counter electrode interface, and second reference electrode interface of the diagnosis-cassette-side interface (second interface) 370, respectively.

The diagnosis-cassette-side interface (second interface) 370 has substantially the same layout as that of the detection-cassette-side interface (third interface) 270 of the nucleic acid detection cassette 200. When the diagnostic cassette is loaded into the nucleic acid detection apparatus 100, the apparatus-side interface (first interface) 150 is electrically connected to the diagnosis-cassette-side interface (second interface) 370. That is, the first working electrode interface, first counter electrode interface, and first reference electrode interface of the apparatus-side interface 150 are electrically connected to the second working electrode interface, second counter electrode interface, and second reference electrode interface of the detection-cassette-side interface 270, respectively.

As shown in FIG. 8, the diagnostic cassette 300 includes ports 310 for fluidically connecting the channel 380 of the diagnostic substrate 330 to the reagent feeding system 120 of the nucleic acid detection apparatus 100, and a window 320 exposing the cassette-side interface 370.

The elements 340 are capacitors or resistors.

As shown in FIG. 17, a capacitor or resistor as the element 340 is wired such that one terminal is connected to a working electrode interface, and the other terminal is connected to a counter electrode interface and a reference electrode interface. In this case, the reference electrode is short-circuited to the counter electrode.

A commercially available solid-state element may be fixed as the element 340 on the diagnostic substrate 330 by soldering, contact bonding, or the like. The size of the element 340 is not specifically limited but is preferably minimized because diagnosis can be performed in consideration of local influences. The size of the element 340 is preferably 1.0×0.5 mm or less, more preferably 0.6×0.3 mm or less, and still more preferably 0.4×0.2 mm or less.

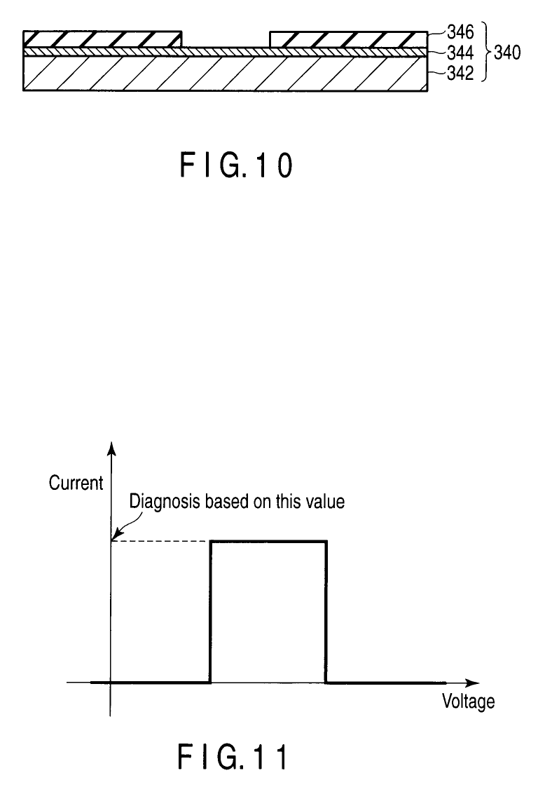

As shown in FIG. 10, the element 340 may be formed of a multilayer structure obtained by forming a thin layer 344 and an insulating layer 346 on a substrate 342. A multilayer structure is preferable because it can be formed in a smaller region than a solid-state element.

The substrate 342 may have a flat or three-dimensional surface. In addition, the substrate 342 may be porous.

The thin layer 344 may be formed by a layer forming method such as sputtering, vapor deposition, or spin coating or a chemical reaction such as thermal oxidation. The thin layer 344 is not limited to any specific material as long as it has a characteristic that can output a signal suitable for diagnosis. It is possible to use Si, GaAs, Cu, Al, Ag, Ti, Cr, or one of their oxides as a layer material. It is also possible to use, as a layer material, an organic material, e.g., polyethylene, ethylene, polypropylene, polyisobutylene, polyethylene terephthalate, unsaturated polyester, fluorine-containing resin, polyvinylchloride, polyvinylidene, polyvinyl acetate, polyvinyl alcohol, polyvinyl acetal, acrylic resin, polyacrylonitrile, polystyrene, acetal resin, polycarbonate, polyamide, phenol resin, urea resin, epoxy resin, melamine resin, styrene-acrylonitrile copolymer, acrylonitrilebutadiene-styrene copolymer, silicone resin, polyphenylene oxide, or polysulfone. It is also possible to use, as a layer material, an alkane skeleton, alkyne skeleton, alkene skeleton, ethyleneglycol skeleton, or a molecule having a nucleic acid strand.

If the element 340 comprises a capacitor, an obtained current value I is determined by

I=C·Vi+k1

where C is a capacitor capacitance, Vi is a voltage scan rate, and k1 is a correction constant.

If the element 340 comprises a capacitor using a thin layer, in particular, the capacitor capacitance C is represented by

C=ε·S/d

where ε is the dielectric constant of the thin layer, S is the area of the thin layer, and d is the average thickness of the thin layer. The dielectric constant ε is a value specific to the material forming the thin layer.

FIG. 11 shows the theoretical current values obtained when measurement is performed by the linear sweep voltammetry method using an element having a capacitance characteristic. If the voltage scan rate is constant, the obtained current value becomes a constant value. For this reason, whether the voltage scan rate is kept constant by the electrochemical measuring system 130 can be diagnosed by comparing the output value obtained by using the diagnostic cassette 300 with Ip1=C·Vi+k1 or Ip2=ε·S/d·Vi+k2 (where k2 is a correction constant) when the element 340 comprises a capacitor using a thin layer. It is also possible to make diagnosis on variations in the contact resistance of an electrical interface between the nucleic acid detection cassette 200 and the nucleic acid detection apparatus 100, and the occurrence/nonoccurrence of disconnection or short circuit in the electrical interface between the nucleic acid detection cassette 200 and the nucleic acid detection apparatus 100. In addition, it is possible to make diagnosis on the presence/absence of variations in local resistance compensation between working electrodes and a counter electrode/reference electrode when measurement is performed in an electrolyte.

Let IFM be the detected current value obtained from a double-stranded nucleic acid in electrochemical detection by the general nucleic acid detection cassette 200, and IMM be the detected current value obtained from a single-stranded nucleic acid. That is, let IFM be the detected current value obtained at the working electrode 240 of the nucleic acid detection cassette 200 that has hybridized with a sample nucleic acid, and IMM (<IFM) be the detected current value obtained at the working electrode 240 of the nucleic acid detection cassette 200 that has not hybridized with a sample nucleic acid. In this case, the capacitor capacitance C of the element 340 desirably falls within the range defined by

(10×IFM−k1)/Vi>C>( 1/10×IMM−k1)/Vi

where k1 is a correction constant.

If the element 340 comprises a capacitor using a thin layer, in particular, the ratio between the area S and layer thickness d of the thin layer forming the element 340 desirably falls within the range defined by

(10×IFM−k2)/(ε·Vi)>S/d>( 1/10×IMM−k2)/(ε·Vi).

As a result, the current value obtained from the diagnostic cassette 300 falls within the range of 10 times IFM to 1/10 IMM and has a current value generally equal to IFM or IMM obtained from the nucleic acid detection cassette 200, thus improving the accuracy of diagnosis.

The element 340 comprises a resistor, the obtained current value I is determined by

I=V/R+k3

where R is a resistance, V is a potential, and k3 is a correction constant.

If the element 340 comprises a resistor using a thin layer, in particular, the resistance R is represented by

R=ρ·d/S

where ρ is the resistivity of the thin layer, S is the area of the thin layer, and d is the thickness of the thin layer. The resistivity ρ is a value specific to the material forming the layer.

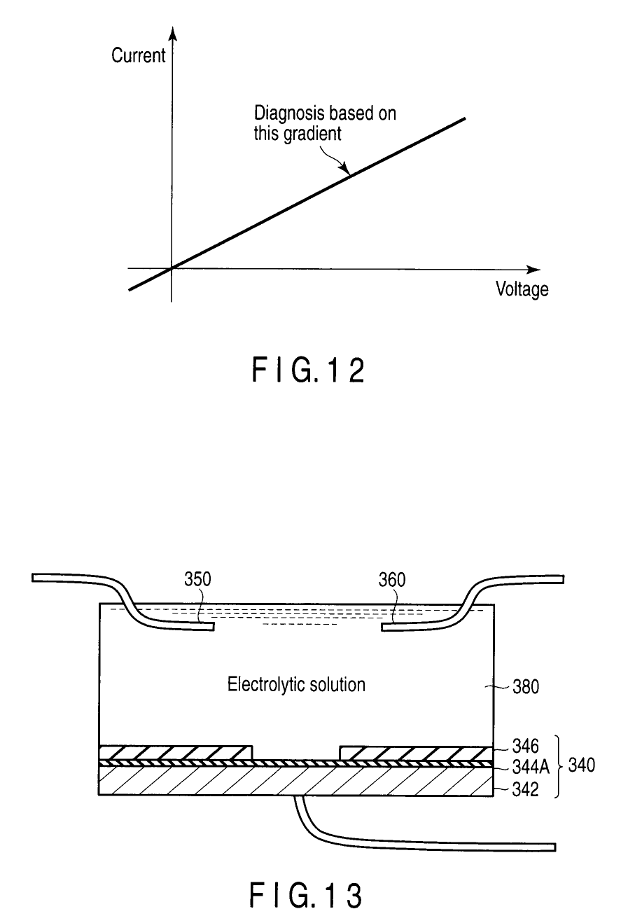

FIG. 12 shows the theoretical current values obtained when measurement is performed by using the linear sweep voltammetry method using an element having a resistance characteristic. If the control potential is accurate, the slope of an obtained current value becomes constant. For this reason, whether the potential difference applied to a working electrode and a counter electrode/reference electrode by the electrochemical measuring system 130 is accurate and the feedback circuit for potential different control is normally operating can be diagnosed by comparing the output value obtained by using the diagnostic cassette 300 with Ip3=V/R+k3 or Ip4=V/(ρ·d/S)+k4 (where k4 is a correction constant) when the element 340 comprises a resistor using a thin layer. It is also possible to make diagnosis on variations in the contact resistance of an electrical interface between the nucleic acid detection cassette and the nucleic acid detection apparatus, and the occurrence/nonoccurrence of disconnection or short circuit in the electrical interface between the nucleic acid detection cassette and the nucleic acid detection apparatus. In addition, it is possible to make diagnosis on the presence/absence of variations in local resistance compensation between working electrodes and a counter electrode/reference electrode when measurement is performed in an electrolyte.

Let IFM be the detected current value obtained from a double-stranded nucleic acid in electrochemical detection by a general nucleic acid detection cassette, and IMM be the detected current value obtained from a single-stranded nucleic acid. In this case, the resistance R of the element 340 desirably falls within the range defined by

V/(10×IFM−k3)>R>V/( 1/10×IMM−k3)

where k3 is a correction constant.

If the element 340 comprises a resistor using a thin layer, in particular, the ratio between the area S and thin layer d of the thin layer forming the element 340 desirably falls within the range defined by

(10×IFM−k4)·ρ/V>S/d>( 1/10×IMM−k4)·ρ/V.

As a result, the current value obtained from the diagnostic cassette 300 falls within the range of 10 times IFM to 1/10 IMM and has a current value generally equal to IFM or IMM obtained from the nucleic acid detection cassette 200, thus improving the accuracy of diagnosis.

In addition, the element 340 may have characteristics. For example, impedance measurement may be performed by using an element having both a capacitance characteristic and a resistance characteristic. Separating the obtained electrical signal into a resistance value and a capacitance value allows efficient diagnosis.

### FIRST EMBODIMENT

A diagnostic cassette has the same arrangement as that shown in FIGS. 8 and 9. Elements 340 comprise capacitors. 60 capacitors are arranged on a glass epoxy substrate. Each capacitor has a very small size of 0.6 mm×0.3 mm, and is located at substantially the same position as the area where a working electrode of the nucleic acid detection cassette is located. One contact of each capacitor is connected to a working electrode pad, and the other contact is connected to both a counter electrode and a reference electrode.

The user who is to diagnose a nucleic acid detection apparatus 100 sets this diagnostic cassette in the nucleic acid detection apparatus 100 like a nucleic acid detection cassette, and performs electrochemical measurement as in the case with the nucleic acid detection cassette. Determining whether the obtained current value falls within a predetermined variation range can diagnose whether the nucleic acid detection apparatus 100 is normally operating.

### SECOND EMBODIMENT

A diagnostic cassette has the same arrangement as that shown in FIGS. 8 and 9. Elements 340 comprise resistors. 60 resistors are arranged on a glass epoxy substrate. Each resistor has a very small size of 0.6 mm×0.3 mm, and is located at substantially the same position as the area where a working electrode of the nucleic acid detection cassette is located. One contact of each resistor is connected to a working electrode pad, and the other contact is connected to both a counter electrode and a reference electrode.

The user who is to diagnose a nucleic acid detection apparatus 100 sets this diagnostic cassette in the nucleic acid detection apparatus 100 like a nucleic acid detection cassette, and performs electrochemical measurement as in the case with the nucleic acid detection cassette. Determining whether the obtained current value falls within a predetermined variation range can diagnose whether the nucleic acid detection apparatus 100 is normally operating.

### THIRD EMBODIMENT

A diagnostic cassette has the same arrangement as that shown in FIGS. 8 and 9. A channel 380 is provided in a substrate in the cassette, and elements 340 are formed in the channel 380. As shown in FIG. 13, each element 340 comprises a capacitor including a silicon substrate 342, an SiO₂ thin layer 344A, and an electrolyte that exists in the channel 380 and is in contact with the SiO₂ thin layer 344A. The capacitor having the SiO₂ thin layer has substantially the same arrangement as a working electrode 240 of a nucleic acid detection cassette 200 covered with an SiO₂ thin layer. 60 capacitors having SiO₂ thin layers are arranged on a glass substrate. A counter electrode 350 and a reference electrode 360 each comprising an Au thin layer are located in the channel 380. The SiO₂ thin layers 344A may or may not face a counter electrode and a reference electrode or may be arranged side by side on the substrate. Each SiO₂ thin layer has a thickness of 50 Å. It suffices if the thickness of each SiO₂ thin layer falls within the range of 5 to 5,000 Å. The peripheral portion of the area is covered with a thick insulating layer so as to form a circle having a diameter of 200 μm. As shown in FIG. 13, all the elements 340, counter electrode 350, and reference electrode 360 are immersed in an electrolyte. One contact of the capacitor including the SiO₂ thin layer 344A and the electrolyte is connected to a working electrode interface, and the other contact is in contact with the electrolyte. One contact of the counter electrode and one contact of the reference electrode are respectively connected to a counter electrode interface and a reference electrode interface, and the other contact of each of the electrodes is in contact with the electrolyte.

The user who is to diagnose a nucleic acid detection apparatus 100 sets this diagnostic cassette in the nucleic acid detection apparatus 100 like a nucleic acid detection cassette, and performs electrochemical measurement as in the case with the nucleic acid detection cassette. Determining whether the obtained current value falls within a predetermined variation range can diagnose whether the nucleic acid detection apparatus 100 is normally operating.

As described in the third embodiment, an electrolyte can be used for measurement for diagnosis. When an electrolyte is to be used, the electrolyte functions as not only an electron supply source but also an element having a resistance and a charge capacitance. Diagnosis using an electrolyte can also diagnose a local solution resistance in a region where a working electrode exists and variations in capacitance in addition to diagnosis using no electrolyte, and hence is more preferable. In the case with a capacitor using a silicon substrate, an SiO₂ layer, and an electrolyte, a phosphoric acid, hydrochloric acid, sulfuric acid, perchloric acid, sodium hydrate, potassium hydrate, hydrofluoric acid, one of various types of buffer solutions, or the like can be used as an electrolyte. The concentration of the electrolyte desirably falls within the range of 100 nM to 10 M.

Although this embodiment has exemplified the nucleic acid detection, it can be used for diagnosis on a measuring apparatus for electrochemical measurement using a cassette as well as an apparatus for nucleic acid detection.

Although it depends on the type of electrochemical detection, this embodiment can be used for general two-electrode and three-electrode type detection methods. Although not specifically limited, the detection technique can be used for impedance (IMP) measurement and the like by linear sweep voltammetry (LSV), cyclic voltammetry (CV), Tafel plot bulk electrolysis (BE), chronocoulometry (CA), chronopotentiometry (CP), amperometry (i-t), differential pulse amperometry (IPAD), normal pulse voltammetry (NPV), differential pulse voltammetry (DPV), square wave voltammetry (SWV), sweep step function (SSF), multi-potential step (STEP), multi-current step (ISTEP), alternating current voltammetry (ACV), or second-harmonic alternating current voltammetry (SHACV).

### Example 1

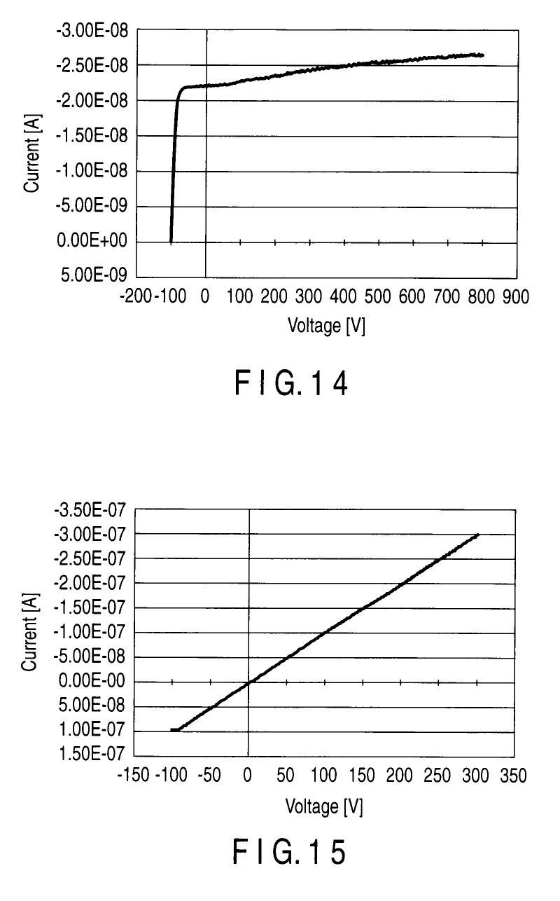

Diagnosis was performed by using the diagnostic cassette according to the first embodiment. FIG. 14 shows the current waveform obtained from one of the 60 capacitors. The electric capacitance value of the capacitor was 0.1 μF, and the voltage scan rate set in the nucleic acid detection apparatus 100 was 0.3 V/sec. Based on the values measured in advance by using an apparatus that normally operates, the threshold current value range allowed in the apparatus is 20 to 30 nA. Since the current values obtained from the 60 capacitors fell within the range of 22 to 27 nA, obviously, the voltage scan rate of the nucleic acid detection apparatus 100 normally functioned.

### Example 2

Diagnosis was performed by using the diagnostic cassette according to the second embodiment. FIG. 15 shows the current waveform obtained from one of the 60 resistors. The resistance value of the resistor was 1 MΩ, and the voltage scan rate range set in the nucleic acid detection apparatus 100 was −0.3 to 0.8 V. Based on the values measured in advance by using an apparatus that normally operates, the scan rate range allowed in the apparatus was 0.29 to 0.31 V/sec. Since the slopes obtained from the 60 resistors fell within the range of 0.298 to 0.302 V/sec, obviously, the voltage control on the nucleic acid detection apparatus 100 normally functioned.

### Example 3

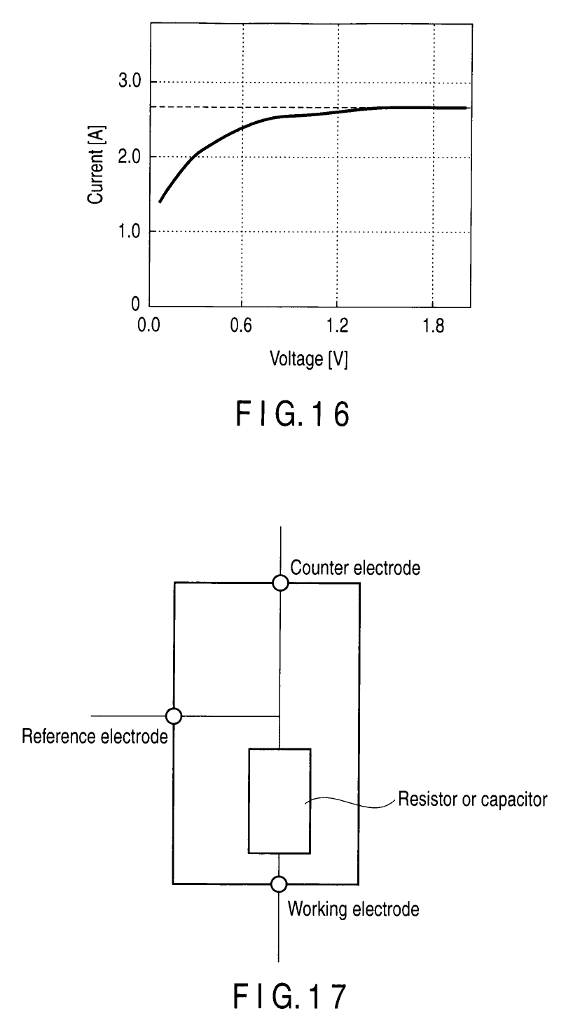

Diagnosis was performed by using the diagnostic cassette according to the third embodiment. FIG. 16 shows the current waveform obtained from one of the 60 capacitors. The voltage scan rate set in the nucleic acid detection apparatus 100 was 0.3 V/sec. Based on the values measured in advance by using an apparatus that normally operates, the threshold current value range allowed in the apparatus is 2.3 to 2.9 μA. Since the obtained current values fell within the range of 2.5 to 2.7 nA, obviously, the voltage scan rate of the nucleic acid detection apparatus 100 normally functioned in the electrolyte.

In this embodiment, by using the diagnostic cassette 300 attachable to and detachable from the nucleic acid detection apparatus 100 like the nucleic acid detection cassette 200, performing electrochemical measurement similar to that using the nucleic acid detection cassette 200 allows diagnosis of the nucleic acid detection apparatus 100. Therefore, the nucleic acid detection apparatus 100 can be easily diagnosed without any expert skill. In addition, this technique allows easy diagnosis when a nucleic acid test is actually performed, and hence allows quick diagnosis on the nucleic acid detection apparatus 100.

In addition, since the elements 340, counter electrode 350, and reference electrode 360 are arranged in the diagnostic cassette 300 in substantially the same layout as that of the working electrodes 240, counter electrodes 250, and reference electrodes 260 of the nucleic acid detection cassette 200, it is possible to perform more accurate diagnosis in measurement using an electrolyte, reflecting external noise, local concentration variations in the solution, and the magnitude of the solution resistance.

Although the embodiments of the present invention have been described with reference to the views of the accompanying drawing, the present invention is not limited to these embodiments. The embodiments can be variously modified and changed within the spirit and scope of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A diagnostic cassette for diagnosing an electrochemical measuring apparatus,
wherein
an electrochemical measuring apparatus performs electrochemical measurement on a sample in a sample cassette, and includes a first working electrode interface, a first counter electrode interface, and a first reference electrode interface,
the sample cassette is attachable to and detachable from the electrochemical measuring apparatus,
the diagnostic cassette comprising:
a second working electrode interface connectable to the first working electrode interface;
a second counter electrode interface connectable to the first counter electrode interface;
a second reference electrode interface connectable to the first reference electrode interface; and
one of a capacitor and a resistor including one terminal connected to the second working electrode interface, and the other terminal connected to the second counter electrode interface and the second reference electrode interface,
wherein the diagnostic cassette being attachable to and detachable from the electrochemical measuring apparatus like the sample cassette.

2. The diagnostic cassette according to claim 1, wherein
the sample cassette includes
a third working electrode interface connectable to the first working electrode interface and a sample working electrode connected to the third working electrode interface,
a third counter electrode interface connectable to the first counter electrode interface and a sample counter electrode connected to the third counter electrode interface, and
a third reference electrode interface connectable to the first reference electrode interface and a sample reference electrode connected to the third reference electrode interface, and
wherein the second working electrode interface, second counter electrode interface, and second reference electrode interface of the diagnostic cassette are arranged in substantially the same layout as that of the third working electrode interface, third counter electrode interface, and third reference electrode interface of the sample cassette.

3. The diagnostic cassette according to claim 1, including the capacitor and further comprising
a channel through which an electrolyte flows,
a diagnosis working electrode located in the channel and connected to the second working electrode interface,
a diagnosis counter electrode located in the channel and connected to the second counter electrode interface,
a diagnosis reference electrode located in the channel and connected to the second reference electrode interface, and
an SiO₂ layer formed on the diagnosis working electrode, and
wherein the capacitor comprises the diagnosis working electrode, the SiO₂ layer, and the electrolyte flowing through the channel.

4. The diagnostic cassette according to claim 3, wherein
the sample cassette comprises
a third working electrode interface connectable to the first working electrode interface and a sample working electrode connected to the third working electrode interface,
a third counter electrode interface connectable to the first counter electrode interface and a sample counter electrode connected to the third counter electrode interface, and
a third reference electrode interface connectable to the first reference electrode interface and a sample reference electrode connected to the third reference electrode interface, and
wherein the second working electrode interface, second counter electrode interface, and second reference electrode interface of the diagnostic cassette are arranged in substantially the same layout as that of the third working electrode interface, third counter electrode interface, and third reference electrode interface of the sample cassette, and
the diagnosis working electrode, diagnosis counter electrode, and diagnosis reference electrode of the diagnostic cassette are arranged in substantially the same layout as that of the sample working electrode, sample counter electrode, and sample reference electrode of the sample cassette.

5. The diagnostic cassette according to claim 3, wherein
the sample cassette is used for nucleic acid detection,
the electrochemical measuring apparatus electrochemically detects a sample nucleic acid, and
letting IFM be a detected current value at the sample working electrode that has hybridized with a sample nucleic acid, and IMM (<IFM) be a detected current value at the sample working electrode that has not hybridized with a sample nucleic acid, a ratio between a capacitor area S and layer thickness d of the SiO₂ layer in the diagnostic cassette falls within a range defined by
(10×IFM−k2)/(β·Vi)>S/d>( 1/10×IMM−k2)/(ε·Vi)
where ε is a dielectric constant and k2 is a correction constant.

6. The diagnostic cassette according to claim 1, wherein the sample cassette is used for nucleic acid detection, and the electrochemical measuring apparatus comprises an apparatus that electrochemically detects a sample nucleic acid.

7. A method of diagnosing an electrochemical measuring apparatus that performs electrochemical measurement on a sample in a sample cassette, and includes a first working electrode interface, a first counter electrode interface, and a first reference electrode interface,
wherein the sample cassette is attachable to and detachable from the electrochemical measuring apparatus, and includes a first working electrode, a first counter electrode, and a first reference electrode,
the method comprising steps of:
loading a diagnostic cassette into the electrochemical measuring apparatus, the diagnostic cassette being attachable to and detachable from the electrochemical measuring apparatus like the sample cassette and including a second working electrode interface connectable to the first working electrode interface, a second counter electrode interface connectable to the first counter electrode interface, a second reference electrode interface connectable to the first reference electrode interface, and one of a capacitor and a resistor including one terminal connected to the second working electrode interface and the other terminal connected to the second counter electrode interface and the second reference electrode interface; and
diagnosing, from an output value obtained by the electrochemical measurement, whether electrochemical control on the metadata measuring apparatus is normally performed.

8. The method according to claim 7, wherein
the sample cassette comprises
a third working electrode interface connectable to the first working electrode interface and a sample working electrode connected to the third working electrode interface,
a third counter electrode interface connectable to the first counter electrode interface and a sample counter electrode connected to the third counter electrode interface, and
a third reference electrode interface connectable to the first reference electrode interface and a sample reference electrode connected to the third reference electrode interface, and
wherein the second working electrode interface, second counter electrode interface, and second reference electrode interface of the diagnostic cassette are arranged in substantially the same layout as that of the third working electrode interface, third counter electrode interface, and third reference electrode interface of the sample cassette.

9. The method according to claim 8, wherein
the diagnostic cassette includes the capacitor and further comprises
a channel through which an electrolyte flows,
a diagnosis working electrode located in the channel and connected to the second working electrode interface,
a diagnosis counter electrode located in the channel and connected to the second counter electrode interface,
a diagnosis reference electrode located in the channel and connected to the second reference electrode interface, and
an SiO₂ layer formed on the diagnosis working electrode,
the capacitor comprises the diagnosis working electrode, the SiO₂ layer, and the electrolyte flowing through the channel, and
the diagnosing step comprises a step of comparing the output value with a value Ip2 calculated by
lp2=ε·S/d·Vi+k2
where ε is a dielectric constant, S is a capacitor area, d is an SiO₂ layer thickness, Vi is a voltage scan rate, and k2 is a correction constant.

10. The method according to claim 9, wherein
the sample cassette is used for nucleic acid detection,
the electrochemical measuring apparatus electrochemically detects a sample nucleic acid, and
letting IFM be a detected current value at the sample working electrode that has hybridized with a sample nucleic acid, and IMM (<IFM) be a detected current value at the sample working electrode that has undergone no hybridization reaction with a sample nucleic acid, a ratio between a capacitor area S and layer thickness d of the SiO₂ layer in the diagnostic cassette falls within a range defined by
(10×IFM−k2)/(ε·Vi)>S/d>( 1/10×IMM−k2)/(ε·Vi)
where ε is a dielectric constant and k2 is a correction constant.

11. The method according to claim 8, wherein
the diagnostic cassette includes the capacitor, and
whether electrochemical control is normally performed is diagnosed by comparing the output value with a value Ip1 calculated by
lp1=C·Vi+k1
where C is a capacitor capacitance, Vi is a voltage scan rate, and k1 is a correction constant.

12. The method according to claim 11, wherein
the sample cassette is used for nucleic acid detection,
the electrochemical measuring apparatus electrochemically detects a sample nucleic acid, and
letting IFM be a detected current value at the sample working electrode that has hybridized with the sample nucleic acid, and IMM (<IFM) be a detected current value at the sample working electrode that has undergone no hybridization reaction with the sample nucleic acid, the capacitor capacitance falls within a range defined by
(10×IFM−k1)/Vi>C>( 1/10×IMM−k1)/Vi.

13. The method according to claim 8, wherein
the diagnostic cassette includes the resistor, and
whether electrochemical control is normally performed is diagnosed by comparing the output value with a value Ip3 calculated by
lp3=V/R+k3
where R is a resistance value, V is a voltage, and k3 is a correction constant.

14. The method according to claim 13, wherein
the sample cassette is used for nucleic acid detection,
the electrochemical measuring apparatus electrochemically detects a sample nucleic acid, and
letting IFM be a detected current value at the sample working electrode that has hybridized with the sample nucleic acid, and IMM (<IFM) be a detected current value at the sample working electrode that has undergone no hybridization reaction with the sample nucleic acid, the resistance value falls within a range defined by
V/(10×lFM−k3)>R>V/( 1/10×IMM−k3)

15. The method according to claim 7, wherein
the diagnostic cassette includes the capacitor and further comprises
a channel through which an electrolyte flows,
a diagnosis working electrode located in the channel and connected to the second working electrode interface,
a diagnosis counter electrode located in the channel and connected to the second counter electrode interface,
a diagnosis reference electrode located in the channel and connected to the second reference electrode interface, and
an SiO₂ layer formed on the diagnosis working electrode,
the capacitor comprises the diagnosis working electrode, the SiO₂ layer, and the electrolyte flowing through the channel, and
the diagnosing step comprises a step of comparing the output value with a value Ip2 calculated by
lp2=ε·S/d·Vi+k2
where ε is a dielectric constant, S is a capacitor area,
d is an SiO₂ layer thickness, Vi is a voltage scan rate, and k2 is a correction constant.

16. The method according to claim 7, wherein
the diagnostic cassette includes the capacitor, and
whether electrochemical control is normally performed is diagnosed by comparing the output value with a value Ip1 calculated by
lp1=C·Vi+k1
where C is a capacitor capacitance, Vi is a voltage scan rate, and k1 is a correction constant.

17. The method according to claim 7, wherein
the diagnostic cassette includes the resistor, and
whether electrochemical control is normally performed is diagnosed by comparing the output value with a value Ip3 calculated by
lp3=V/R+k3
where R is a resistance value, V is a voltage, and k3 is a correction constant.
